(19) United States
(12) Patent Application Publication
(10) Pub. No.: US 2006/0102528 A1
(43) Pub. Date: May 18, 2006

(54) Automatic analysis or inspection system for object travelling on a support

(76) Inventor: Antoine Bourely, La Tour D'Aigues (FR)

Correspondence Address: YOUNG & THOMPSON, 745 SOUTH 23RD STREET, 2ND FLOOR, ARLINGTON, VA, 22202, US

(21) Appl. No.: 10/524,016

(22) PCT Filed: Aug. 8, 2003
(86) PCT No.: PCT/FR03/02500

§ 371 Date: Oct. 17, 2005

(30) Foreign Application Priority Data
Aug. 9, 2002 (FR) 02/10182
Sep. 13, 2002 (FR) 02/11408

(51) Int. Cl. B07C 5/00

(52) U.S. Cl. 209/576

(57) ABSTRACT

An automatic analysis or inspection system for objects traveling on a support which includes at least one illumination element (4), preferably with a large spectrum and at least one detection element or a detector (5), the two elements being arranged above a flow of objects (2). The objects are selected such that at least a part thereof is transparent. The inventive system is characterized in that the support (3) reflects in a diffused manner at least 50% of light received within the interested spectral range.

The invention relates to the field of the inspection and/or optical recognition of products or articles, in particular in relation to the sorting of these objects, and relates to an improved system and process for the recognition and/or inspection of objects, in particular containers, packages or similar.

There are already numerous devices, installations and processes for recognising and/or inspecting objects in which the objects travel in a planar flow on a support, such as those, for example, described in the French patent application No. 01 03700 of 19 Mar. 2001 (publication No. 2 822 235).

Sorting machines with planar architecture on the market operate with black conveyor belts, generally made of rubber.

For reliability in industrial operation, these machines, particularly the one in the above-mentioned application, operate with illumination and a detection system both placed above the conveyor. They therefore use light backscattered by the objects analysed, and not light transmitted through the objects.

It maybe:
a “colour” sort performed by video camera operating in the visible range (400 to 800 nm),
a “material” sort operating in the near-infrared or NIR range (near infrared: 800 to 2500 nm).

The backscattered light from the objects is weak, particularly for transparent objects. If a sheet of white paper is used as a reference (100% level), an opaque white plastic returns 60 to 80% in the NIR, and up to 100% in the visible; the black rubber belt returns about 15%, and a smooth transparent object such as a colourless soft-drinks bottle returns 20% of the light, of which 15% comes from the belt. For an object that is not smooth, such as a ribbed bottle, the final level is a little better: 25 to 30%, of which 15% still comes from the belt.

Such low levels explain why these objects are difficult to detect. Very visible characteristics can still be recognised, for example the signature of a PVC (polyvinyl chloride) compared with a PET (polyethylene terephthalate) analysed in NIR. In contrast, more subtle differences become difficult to see, such as:
the distinction between PET and PET-G (NIR range),
the distinction between colourless and light-blue objects (visible range).

A solution found in the industry consists in operating in transmission without a support: the objects are analysed as they fall by placing the illumination and the detector on either side of the flow of objects. For example, the detector is placed above the flow and the illumination below. A serious drawback of this approach is that at least one of the two elements is quickly dirtied by the passage of the flow.

The object of the present invention is to overcome the drawbacks and limitations of the present systems and processes.

The invention also proposes a solution that can be used both in “material” detection or sorting and in “colour” detection and sorting.

Accordingly, the invention relates to an automatic analysis or inspection system for objects travelling on a support, comprising at least one illumination means, preferably with a wide spectrum, and at least one detection means or detector, both placed above the flow of objects, the objects being at least in part transparent, system characterised in that the support reflects in a diffused manner most, at least 50%, of the light received in the spectral range concerned.

Advantageously, the support reflects at least 70% of the light received and, preferably, the surface of the support on which the objects rest is coloured white.

The system may also comprise a support-cleaning means or station, particularly of the surface at least of the support carrying the objects, said support having the form of an endless conveyor belt travelling in a loop.

Thus, the basic principle of the invention is to use a white support to eliminate the drawbacks of the prior art referred to above.

The material for producing such supports, in the form of conveyor belts, may for example be rubber or a white polymer.

The invention will be better understood with the aid of the description below, which relates to a preferred embodiment, given as a non-limitative example, and explained with reference to the accompanying schematic drawing, in which the only figure is a partial schematic illustration of a system according to the invention.

In what follows, the movable support 3 carrying the objects 2 to be analysed and inspected may also be referred to as a conveyor belt.

Thus, according to the invention illustrated in the accompanying figure, the system 1 comprises at least one illumination means 4, preferably with a wide spectrum, and at least one detection means or detector 5, both placed above the flow of objects 2, the objects being at least in part transparent, the system being characterised in that the support 3 reflects in a diffused manner most, at least 50%, of the light received in the spectral range concerned.

Advantageously, the support 3 reflects at least 70% of the light received and preferably is produced in or covered with a white material.

In general, an object is said to be white when it reflects a high percentage (at least 70%) of all radiation received in the spectral range concerned: thus, a belt that reflects at least 70% of the intensity between 800 and 2500 nm is “white” in the NIR range.

If the total illumination received per surface unit is marked E, the total emittance of the support (in all directions) is R×E, where R, the reflectance of the support, is at least 70%.

The definition of the term “white” in the context of the present is wider, since it is not necessary for R to be identical in all wavelengths: it is sufficient that the proportions are high and fixed in time (for example, 82% at 1100 nm, 90% at 1500 nm, 70% at 1700 nm).

In the context of a preferred implementation of the invention, a partially transparent object 2 is considered placed on a white support 3 and lit from above at an oblique angle to the vertical of the support 3, to avoid specular reflections. The detector 5 receiving the light is also placed above the object 2, but not necessarily in the same alignment as the wide-spectrum illumination means 4. The arrangement is chosen simply so that the specular rays (in dotted lines in the figure) do not go towards the detector 5.

The object 2 is supposed to be perfectly smooth, so that no specular ray touches the detector 5.

The light L received by the detector therefore consists of an accumulation of the following three fractions:
the diffused reflection fraction Ds of the upper layer 2′ of the object 2; this light has partly traversed said upper layer;
the diffused reflection fraction Di of the lower layer 2″ of the object 2, which has partly traversed this lower layer, and has completely traversed the upper layer twice: on the outward and return travel;
the fraction T×R reflected by the surface of the support 3, which has completely traversed four thicknesses of the object 2: the two layers 2′ and 2″ of the object before touching the support, and those same two layers 2′ and 2″ when returning. In this fraction, R is the reflectance of the support and T represents the losses linked to transmission through the object (see below).

Of course, the detector 5 receives only a small part of this light: this part is proportional to the size of the pixel observed (the elementary observation zone or window) and the dimension of the receiving optics associated with the detector 5, the unit being characterised by a single sensing coefficient, marked C.

This is then simply: L=(Ds+Di+T×R)×E×C (1)

As to the support's pixel, this returns Ls=R×E×C (2) to the detector 5

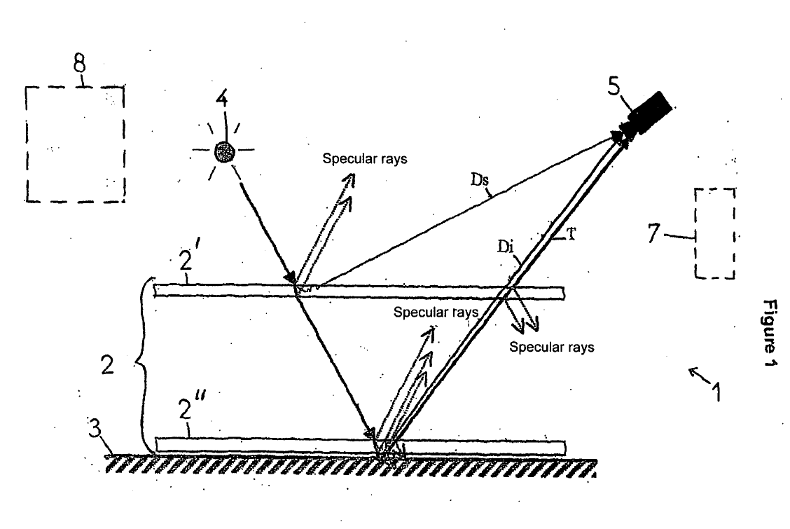

If the image of a perfectly transparent glass bottle, a product that does not absorb in the infrared range is taken (by scanning), the result is Ds=Di=0. Moreover, according to the laws of reflection for materials with a refraction index of about 1.5 (as is the case for the glass bottle), we know that the losses by specular reflection at each optical interface (diopter) are about 4% of the incident flow in the conditions of the figure (non-grazing incidences). In FIG. 1, there are in all nine diopters (two for each of the four layers of the object traversed, plus one on the support).

In the above-mentioned case, the term T is then given by the following formula: T=(1−0.04)⁹=0.69, or 69%.

By dividing the equations (1) and (2) by each other, we find: L/Ls=T.

In this case, T represents directly the luminance ratio measured between the object 2 and the support 3: in practice a fall of about 30% is measured effectively, which confirms the validity of the model.

By replacing the glass object with a transparent plastics material, two effects offset each other, namely:
non-zero terms Di and Ds are added to the measured signal:
T is reduced in several ways: losses by diffusion in each layer traversed (four in all), and losses by absorption in these same layers (these losses are favourable, as it is they that provide T with useful information, namely the selective absorption of the material). We note simply that T is lower than its previous value: T<69%.

A first advantage of the system 1 proposed above in relation to FIG. 1 consists in the fact that the support 3 can itself be used as a reference, without the need for a control object. (This is not possible with a black support, as the signal levels are too low and not repetitive enough to be used for this purpose. A detachable metal plate is therefore used instead).

The 100% level is thus, by definition, that of the white support 3 free from any object, in normal illumination conditions. Thus the absolute measurements on the detector are converted into intensities relative to the local luminance of the support: I=L/Ls.

By applying (1) and (2), we find: I=(Di+Ds)/R+T (3)

In other words, the luminance of the objects 2 is evaluated in relation to the support 3 and not in relation to a perfect diffused reflector. This definition allows for easy and frequent online checks, and even allows frequent update of the reference: only an image of an a zone of the support without any object on it need be taken and then turned into a new reference, and the effects of ageing of the lamps and sensors, the dirtying of the support and the protection glass, etc. are thus continuously included in the processing and evaluation of the recovered signals.

According to the invention, the detection or inspection process used by the system in the accompanying figure thus measures the value of Ls:
at each point of the support,
for each sensor (wavelength range, or “band”),
continuously, (by only using the support's pixels for updates).

A second advantage of the system 1 proposed above is an improvement in the detection of the presence of a transparent object 2 on the support 3.

The simplest method of detecting the presence of an object is to measure the difference in luminance between it and the support.

We detect simply that: I=(Di+Ds)/R+T≠1.

For a smooth colourless transparent plastic, the values measured are Ds+Di≈5 to 10%, T≈60%; for a white support, we measure R≈80%. We find that I≈65 to 70%.

The total luminance is between 65 and 70% of that of the support, and dominated by the transmission.

On the other hand, on a black support, we measure R≈15%, and Di+Ds is unchanged.

We then have Iₘᵢₙ=5/15+0.6=0.93 and Iₘₐₓ=10/15+0.6=1.27.

The luminance is not much greater than that of the support and may even be equal to it. Detection of presence is therefore much easier with a white support, since the distinction is much clearer.

To summarise, the principal effect that improves detection on a white support is that the luminance is lower than the support, not higher, due to the losses by specular reflection at all the interfaces.

It should however be noted that on a white support, any brilliance on the object due to specular rays hitting the detector because of inappropriate orientations, may reverse the result: the object may then appear clearly more luminous than the support.

Moreover, in the case of opaque objects 2, T=0, and only Ds is not zero: the support plays no role. We have: I=Ds/R.

Thus, the distinction between object and support may disappear totally if Ds=R, in other words if the object is opaque and white like the support. The presence of white objects may therefore not be detected. However, in practice, this rarely happens with plastic bottles in NIR. Even a white PEHD bottle is somewhat “grey” in NIR: it absorbs 30 to 40% of radiation.

In summary, a white support allows good detection of presence for all objects other than those that are perfectly opaque and white.

A third advantage of the assembly described is to detect black or dark objects. This seems clear from the above, but this category of objects is undetectable on a black support.

Indeed, for visual sorts, the fact that the object is black constitutes all the information.

For material sorts, its spectrum must still be determined, which may be difficult, with very low signal levels. Even if the spectrum is not recognised, it may at least be possible to remove the object from the main flow as a black object, to be re-sorted by a specialised system. This strategy is suitable for packages, where black and dark objects are very much the minority.

A fourth advantage of the system described and illustrated in the accompanying figure is to improve the useful content of the light received by the detector 5.

On this subject, it should be recalled that it is the differential absorption between the various bands of the system that give the useful information: a product appears red when it absorbs green and blue radiation (more than red).

The support itself has an intensity (see formula 3) equal to 1 for all bands, while it may vary for other objects.

We therefore have a second means of distinguishing the object on the support, if the average luminance (on all bands) is very close to that of the support.

At the end of the detection or inspection process, where a pixel recorded by the detector belongs can be discriminated in the following manner:
if the average luminance is close to 1 and if the luminance of each band is close to 1;
then said pixel belongs to the support 3;
otherwise said pixel belongs to an object 2 or corresponds to an object.

In practice, differences in relative intensity of 1 to 3% are measured on the support (see formula (3)) between bands. On the other hand, for the objects to be analysed, the differences between bands are between 5% and 50%, which allows for good distinction.

The useful content is present to a small extent in the term Ds (diffusion in a layer), markedly more than in the term Di (two layers traversed completely, plus a diffusion), and even more in the term T (four layers traversed).

On a black support, these three terms are of comparable importance. Moreover, the black support tends to pollute the signal by its own spectral signature, which is not neutral.

On a white support, the term T is clearly dominant: there is thus a benefit from the four object layers traversed. Moreover, if the support serves as a reference, its own spectral signature is neutral, and is thus no longer a problem. Thus, in theory, even if the support is made of white PVC, and a transparent PVC bottle is placed on it, it can be distinguished.

Of course, for an opaque object, the choice of support in no way changes the useful content, but the signatures are generally already very good.

One point to note in the context of the practical implementation of the invention is the constraint of keeping the white support relatively, or even very clean, in particular for colour detection.

Indeed, the cleanliness of the support is a known problem in the visible, where coloured dirt on the support may distort the colours of the transparent objects placed on it. On the other hand, it is very unlikely that dirt has a signature close to that of the material to be analysed in NIR.

The invention will therefore apply primarily to material sorts, and initially in environments where the support is washed relatively often, in particular on plastics material bottle washing lines. If there is sufficient washing, the use of a white support can be envisaged for subtle colour distinctions of transparent objects.

As shown in the accompanying figure, the system may also comprise a cleaning means or station 7 for the support 3, particularly the surface at least of the support carrying the objects 2, said support being in the form of an endless conveyor belt, travelling in a loop.

Finally, a computer unit 8 will control the means 4, 4′, 5 and/or 7 and the support 3, as well as the processing of the signals recorded by the detector 5 and the evaluation thereof, for example with a view to subsequent action on the objects 2 analysed or inspected.

The detailed production and operating method of the system according to the invention will not be described below, since this information is accessible to the person skilled in the art given the many existing systems.

Of course, the invention is not limited to the embodiment described and illustrated in the accompanying drawing. Modifications are possible, particularly from the point of view of the composition of the various elements or by substitution of technical equivalents, without thereby departing from the scope of protection of the invention.

1-4. (canceled)

5. Automatic analysis or inspection system for objects travelling on a support, comprising at least one illumination means, preferably with a wide spectrum, and at least one detection means or detector, both placed above the flow of objects, system characterised in that the objects (2) are at least in part transparent, in that said support (3) reflects in a diffused manner most, at least 50%, of the light received in the spectral range concerned and in that detection of the presence of transparent objects is based on the exploitation of the lower luminance of said objects compared with that of the support (3).

6. System according to claim 5, characterised in that the support (3) reflects at least 70% of the light received.

7. System according to claim 5, characterised in that the surface of the support (3) on which the objects (2) rest is coloured white.

8. System according to claim 5, characterised in that it comprises a multi-band detector (5) of which the respective absorptions or luminances allow discrimination of where the pixel recorded belongs compared with the average luminance or absorption, said pixel only belonging to the support (3) if the average luminance and the luminances of all the bands are close to 1.

9. System according to claim 5, characterised in that it comprises a multi-band detector (5) of which the differential absorptions between the various bands provide useful information for distinguishing the objects (2), said detector (5) receiving principally a fraction of light (T) that has traversed four thicknesses of the objects.

10. System according to claim 5, characterised in that it also comprises a cleaning means or station (7) for the surface of the support (3) carrying the objects (2), said support being in the form of an endless conveyor belt travelling in a loop.
